(19) United States
(12) Patent Application Publication
(10) Pub. No.: US 2008/0171379 A1
(43) Pub. Date: Jul. 17, 2008

(54) COMPOSITIONS AND METHODS FOR REMOVING HARD WATER DEPOSITS WITH GROWTH MEDIUM

(76) Inventor: Thomas M. Donndelinger, Nampa, ID (US)

Correspondence Address: KIRTON AND MCCONKIE, 60 EAST SOUTH TEMPLE,, SUITE 1800, SALT LAKE CITY, UT, 84111, US

(21) Appl. No.: 11/972,750

(22) Filed: Jan. 11, 2008

Related U.S. Application Data
(60) Provisional application No. 60/884,561, filed on Jan. 11, 2007.

(51) Int. Cl. C12S 9/00

(52) U.S. Cl. 435/264

(57) ABSTRACT

Compositions and methods for removing hard water deposits through the use of a microorganism growth medium are disclosed. Any known or novel growth medium may be used for the purpose of removing hard water deposits. The growth medium may be applied to the hard water deposits, left long enough for background ambient bacteria to grow and release their byproducts, and the medium and cells or microorganisms that have grown may then be removed using any conventional method. In some variations of embodiments of the methods, growth media may be inoculated with specific types of cells and/or microorganisms, it may be heated or cooled, it may mixed, and/or it may be kept moist to optimize cell or microorganism proliferation.

### CROSS-REFERENCE TO RELATED APPLICATION

This application claims the benefit of U.S. Provisional Patent Application 60/884,561, filed Jan. 11, 2007.

### BACKGROUND OF THE INVENTION

This application relates generally to compositions and methods for removing hard water deposits. In particular, this application relates to compositions and methods for removing hard water deposits through the application of growth medium (or growth media). The growth medium may allow cells and microorganisms to grow and create byproducts that remove hard water deposits without harming the underlying substrate.

A short explanation of hard water deposit formation is given below. As rain falls, it absorbs carbon dioxide and creates carbonic acid, which at ordinary environmental pH exists mostly as bicarbonate. Microscopic marine organisms take up the bicarbonate as carbonate to form calcite skeletons. Over millions of years, these calcite skeletons have built up extensive limestone deposits. Additionally, over millennia, bacteria have released magnesium, manganese, and calcium ions from plants. These ions have also formed large deposits of calcium and magnesium carbonate in many places across the earth. For example, manganese hydroxide or manganese carbonate deposits are apparently produced by bacteria that have extracted manganese from plant life. Further, ferrous ions found commonly in groundwater allow the growth of iron fixing bacteria, such as siderocapsa, gallionella, spirophyllum, crenothrix, and leptothrix. Such bacteria may then oxidize iron and manganese and thereby cause precipitation of iron scale and/or manganese hydroxide.

As groundwater becomes slightly acidic due to absorption of carbon dioxide from the air and from the respiration of bacteria in the soil, groundwater becomes an effective solvent for such deposits. The solvency characteristics of water may be further enhanced when water interacts with other materials, such as pollutants, in the case of “acid rain.” When water flows through and over areas consisting chiefly of calcareous and other limestone based rocks, the water dissolves small amounts of these calcium carbonate surfaces. In some geographic locations, deposits of iron, aluminum, phosphorus, manganese, and other elements may also be found at elevated levels and may be dissolved by water that is slightly acidic. The flowing water may dissolve and retain in solution small amounts of calcium carbonate and other minerals. As the water continues to flow, it may continue to dissolve additional minerals, but may do so at a decreasing rate as the water reaches dynamic equilibrium.

The dissolved minerals may continue to stay in solution and have no particular tendency to precipitate or lose their solubility, unless the mineral content of the water becomes oversaturated, such as by evaporation of the water solvent, or the solubility is changed such as by temperature or pressure changes. For example, as water evaporates, the mineral content of the water may become oversaturated and the minerals may precipitate out of solution. Similarly, as water is heated in a boiler, or as water exits a pipe and flows into a faucet, the minerals in the water may precipitate out of solution and form calcium carbonate, or other mineral deposits.

These mineral or hard water deposits can cause many unwanted problems. For example, hard water deposits may be unsightly, cause unwanted insulation (e.g., in boilers), clog pipes, damage valves, damage appliances, and so forth. Because hard water deposits are generally insoluble in pure water and tend to be very hard, people often go to great lengths and expend large amounts of energy to remove them.

For example, in some instances, people may use strong acids, such as muriatic acid (HCl), sulfuric acid, or oxalic acid to dissolve and remove hard water deposits. Nevertheless, such methods for hard water deposit removal may have many drawbacks. For example, workers who remove hard water deposits with acids may be exposed to harmful fumes as well as the corrosive chemical(s). Acids may also damage and etch glass, paint, metal, limestone, marble, and other surfaces. Further, if not handled correctly, acids may damage the environment.

In other instances, people may use machinery, such as sandblasters, to remove hard water deposits. This machinery also tends to come with great costs. For example, a sandblaster may remove a decorative finish or change the color of the surface that is being cleaned. Additionally, such methods may be expensive and impractical for common usage.

In yet other instances, people may try to scrape off hard water deposits with tools or abrasives. For example, a person may try to remove deposits from the inside of a large boiler with a chisel. In another example, a person may try to remove deposits from glass with steel wool or a razor blade. In each of these examples, the removal of hard water deposits may damage the surface and require a high expenditure of energy.

In still other instances, people may use silicone treatments to fill pores in a surface and cause water to sheet-off the surface, and thereby prevent mineral buildup. Once again, such treatments may have shortcomings. For instance, the silicone covering may form an unwanted high gloss on the surface to which it is applied, it may cloud over time, and may collect debris.

It will be appreciated that there is a need in the art for effective methods for removing hard water deposits in a way that is non-hazardous, natural, economical, non-corrosive, and non-abrasive.

### BRIEF SUMMARY OF THE INVENTION

This invention relates to compositions and methods for removing hard water deposits. In particular, it relates to compositions and methods for removing hard water deposits through the use of a microbial growth medium. In some embodiments, any known or novel growth medium may be used for the purpose of removing hard water deposits. In some embodiments, the growth medium may be applied to hard water deposits, left long enough for background bacteria (those found naturally on the surface and surroundings of the area being cleaned) to grow and release their byproducts, and the medium and cells or microorganisms that have grown may then be removed using any conventional method. In other embodiments, an object containing hard water deposits may serve as a container for growth media, may be used to incubate the cells and/or microorganisms that may produce byproducts that remove hard water deposits, and the container may then be emptied and/or rinsed clean. In some variations of embodiments of the methods, growth media may be inoculated with specific types of cells and/or microorganisms, may be heated or cooled, may be mixed, and/or may be kept moist to optimize cell or microorganism proliferation.

### BRIEF DESCRIPTION OF THE DRAWINGS

In order that the manner of the features, advantages, and benefits of the invention may be obtained and may be readily understood, a more particular description of the invention briefly described above will be rendered by reference to specific embodiments thereof that may be illustrated in the appended drawing. Understanding that this drawing depicts only a typical embodiment of the invention and is not therefore to be considered to be limiting of its scope, the invention will be described and explained with additional specificity and detail through the use of the accompanying drawing in which:

FIG. 1 is a flow chart of some embodiments of a method for removing hard water deposits through the use of growth medium.

### DETAILED DESCRIPTION OF THE INVENTION

The following description provides specific details in order to provide a thorough understanding of the invention. Nevertheless, the skilled artisan would understand that the described compositions and methods can be applied without employing these specific details. Indeed the compositions and methods can be applied by modifying the described compositions and methods and they can be used in conjunction with any apparatus and/or techniques conventionally used. While this invention is described for use in hard water deposit removal, it could be used for the removal or diminution of any unwanted material, including any type of mineral deposit, metal oxide, or surface oxidation (e.g., iron oxide, alumina, silica, aluminum oxide, magnesium oxide, etc.). Additionally, the described compositions and methods may be used to clean any material or surface. For example, the described methods and compositions may be used to remove hard water deposits from various surfaces including, but not limited to, glass, brick, stone, mortar, cement, porcelain, tile, ceramic, fiberglass, metal, and plastic.

The described invention may be used to remove hard water deposits and other mineral deposits through the use of a growth medium. In some embodiments, growth medium may be applied directly to hard water deposits disposed on a substrate. The growth medium may then be allowed to set so that cells and/or microorganisms may grow, or proliferate, and produce byproducts (e.g., carbon dioxide, oxygen, water, acids, etc.). These cells, microorganisms, and/or their byproducts may help dissolve hard water deposits and other materials. The medium may then be easily removed, along with some or all of the hard water deposits through any conventional method, such as by washing.

In some embodiments, the present invention relies on cells, microorganisms, and their byproducts to remove hard water deposits. Accordingly any type of cell or microorganism (i.e., both eukaryotic and prokaryotic) may be used, especially those that can aid in the removal of hard water deposits. For example, any type of bacteria, fungi, and/or protozoan may be grown and used to remove hard water deposits. In one example, any type of bacteria may be grown, including any aerobic, anaerobic, halophile, gram-positive, gram-negative, photosynthetic, cyanobacteria, spitochete, nonphotosynthetic bacteria, etc. Accordingly, compositions used in this invention may comprise growth medium for the proliferation of such cells and/or microorganisms.

In some aspects, growth medium that allows the proliferation of any cells and/or microorganism may be used to remove hard water deposits. Any novel or known growth media may be used to promulgate cell and/or microorganism growth, which in turn may create byproducts that remove hard water deposits. As used herein, a growth medium may be any object in which any microorganism or cell (e.g., bacteria, fungi, yeast, protozoan, plant cell, or animal cell) may experience any form of growth or proliferation.

In some instances, a suitable growth medium may comprise a carbon source and a nitrogen source. In such embodiments, any carbon and nitrogen source may be used to grow cells and/or microorganisms. For example, a suitable carbon source may include compounds such as glucose, glycerol, and weak acids (e.g., acetic, citric, and ascorbic acid). Some examples of a nitrogen source may include ammonium salts (e.g., ammonium sulfate and ammonium nitrate), proteins, peptides, amino acids, and inorganic nitrogen compounds.

In other instances, a suitable growth medium may comprise a carbon source, a nitrogen source, as well as any other desired element(s) or material(s), such as iron, sulfur, casein hydrolysate, potassium nitrate, meat extract, peptone, lactose, tryptone, protein, yeast extract, sodium chloride, sodium citrate, sodium ammonium phosphate, magnesium sulfate, gelatin, and so forth, to enhance the microbiological growth medium. Further, these growth media may be defined, and have known quantities of all ingredients, or the media may be undefined, and the ingredients may vary in composition depending on the source. Some examples of suitable growth media may include nutrient broth, Lysogeny broth (“L-B medium”), casein peptone flour peptone broth, algae culture broth, BG11 broth, glucose broth, fungal broth, Hanahan's broth, NZM broth, Mueller Hinton broth, superbroth, etc., as are commonly known in the art.

In some embodiments, growth medium that is designed for specific types of cells or microorganisms may be used in order to remove hard water deposits. Because some cells may be incapable of growth without the provision of certain requirements, particular ingredients may be added to a growth medium in order to promote the growth of certain cell types. For example, nutrients, chemicals, growth factors, and the like may be added to a growth medium in order to give certain cells and/or microorganisms preferential growth opportunities. Some examples of such media may include Mossel broth, malt extract broth, M-azide broth, liver broth, Lauryl sulfate broth, and so forth. For example, a malt extract broth may be used to grow yeast over other cells or microorganisms.

In some cases, the growth medium may also be made selective to certain cells and/or microorganisms according to the addition of reagents that are specific to certain types of cells and/or microorganisms. Any cell or microorganism specific reagent may be used to allow one type of cell to grow while other types of cells die. Some examples of such reagents may include drugs, such as kanamycin, neomycin, penicillin, amoxicillin, carboxicillin, lincomycin, gentamycin, and so forth.

Additionally, in some embodiments, the growth medium may optionally contain agar, as known in the art, to congeal the medium. The addition of agar may tend to allow the medium to cling to a surface and retain moisture for a longer period. This may allow the cells and/or microorganisms to thrive on the growth medium on hard water deposits for longer periods of time.

The aforementioned growth medium may be used in any manner to remove hard water deposits. As previously mentioned, the growth medium may be applied to a surface, left on the surface in order to allow cells and/or microorganisms to proliferate and produce byproducts, and then the medium and cells and/or microorganisms may be removed. Although many variations are possible and the steps need not be followed sequentially, each of the aforementioned methods for removing hard water deposits is described hereinafter.

The growth medium may be applied to any surface using any method, or in any manner, that allows cells or microorganisms to grow and/or produce byproducts. For example, the growth medium may be sprayed on a surface, it may be brushed on, it may be misted on, it may be poured on, or it may be applied using any other conventional method. Some examples of such methods are described below.

In one example of a method for applying growth medium to a surface in order to remove hard water deposits, the growth medium may be sprayed directly onto the hard water deposits using any conventional means. For example, a person may spray growth medium on a desired surface with a spray bottle. In this example, a person may be able to apply, and confine, the growth medium to desired locations. Also, in this example, the growth medium may be sprayed on the desired surface multiple times in order to keep the application spots moist and the cells and/or microorganisms growing optimally.

In another example of a method for applying the growth medium to hard water deposits, the growth medium may be misted on the desired surface. In such cases, the growth medium may be misted using any known means or method. For example, growth medium may be continuously applied to a desired surface through the use of a pressurized tube with perforations or one or more orifices. Some examples of such tubes may include a soaker hose, or any other known or novel mister. By applying the growth medium in this manner, the cells and/or microorganisms may remain moist and receive a continuous supply of growth medium for nutrients.

In yet another example of a method for applying a growth medium to hard water deposits, the growth medium may be placed inside of a container that has hard water deposits on the inner surface. In such instances, the growth medium could be placed in a container and the container could be filled to any desired level. For example, a boiler with inner surfaces that are covered in hard water deposits may be filled to a level where the growth medium submerges the deposits. The cells and/or microorganisms may then produce byproducts that directly interact with the hard water deposits.

In still another example of a method for growth medium application, an object) covered with hard water deposits may be placed inside of a container filled with growth medium. For example, a shower head may be placed in a bucket of growth medium in order to dissolve hard water deposits.

No matter the method used to apply the growth medium to the desired surfaces, the growth medium may have any moisture content throughout the entire hard water deposit removal process. For example, in some embodiments, the growth medium may be applied and then be allowed to substantially air dry. In other embodiments, the growth medium may be applied and continually kept moist through the application of additional growth medium, water (e.g., from dew), or any other moisturizer. However, when growth medium is diluted or desiccated, the hard water deposit removal process may be slowed.

In some embodiments of the methods for applying the growth medium to a surface, the method of application and care may determine which cells and/or microorganisms proliferate best, and/or which byproducts are produced. For instance, growth medium could be applied and cared for so as to allow anaerobic bacteria to grow and anaerobic byproducts to be produced (e.g., alcohol and acid), or to allow aerobic cells, microorganisms, and/or byproducts to increase. For example, a boiler could be filled with growth medium, capped, any oxygen may be removed, and anaerobic respiration may occur. In another example, growth medium may be applied to a surface, exposed to air for the duration of its application, and aerobic cells and/or microorganisms may flourish. For example, a growth medium may be sprayed on a brick wall and be exposed to the ambient air until the growth medium is removed. In this example, aerobic cells and/or microorganisms may grow and produce aerobic byproducts.

Additionally, the temperature of the growth medium may also influence which cells or microorganisms grow and the rate at which they proliferate and produce byproducts. Although the growth medium may be used in any temperature range that promotes growth or proliferation of cells and microorganisms, in some embodiments, temperature extremes may not be preferred. For example, because many common microorganisms and cells may not grow, proliferate, and/or produce byproducts optimally at relatively high or low temperature, such temperatures may not be favorable for the hard water removal process.

Once applied, the growth medium may be left on a surface long enough to allow the cells and/or microorganisms to proliferate and/or produce sufficient byproduct to remove any or all of a hard water deposit. This period may be any length of time. For example, the growth medium may be applied and bacteria may be allowed to grow for several hours before the growth medium is removed. In another example, the growth medium may be allowed to set for a day or more (e.g., 1-10 days) in order to allow the cells and/or microorganisms to grow and produce enough byproduct to remove hard water deposits. Usually, the growth medium will allow the cells and/or microorganisms to proliferate for 2-4 days.

Once the growth medium has set for a sufficient amount of time to allow cell and/or microorganism byproducts to remove some or all of one or more hard water deposits, the growth medium may be removed. Any method known in the art for removing growth media from a surface may be used. For example, the growth medium may be rinsed off of a wall with water from any source (e.g., a garden hose). In another example, the growth medium may be rinsed off a window with alcohol, and thus kill the remaining cells and/or microorganisms. In yet another example, the growth medium may be left on the surface of a wall and be removed naturally (e.g., by the rain).

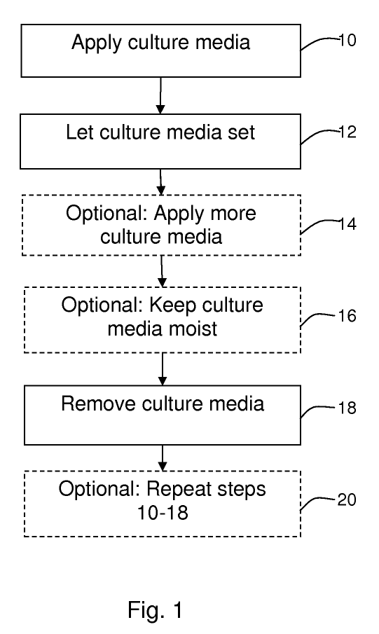

Although the methods for removing hard water deposits with growth medium may be completed in any desired manner or by any desired means, one example of a typical method is illustrated in FIG. 1. That Figure is provided as an exemplary embodiment, meaning that variations are possible and that the steps need not be followed sequentially. At step 10, the Figure illustrates that any desired growth medium may be applied to any desired surface, in any desired manner. Step 12 shows the growth medium may be left for any desired period of time in order to allow the cells and/or microorganisms to grow and produce byproducts. Next, at step 14, additional growth medium may optionally be added in order to keep the nutrient levels high and growth at optimal levels. This addition of growth medium (or other moisturizers and nutrients) may optionally serve to keep cells and/or microorganisms moist, as shown at step 16. Step 18 illustrates that once the growth medium has set for a sufficient amount of time, the growth medium may be rinsed away, along with hard water deposits. Finally, in step 20, the entire process may be repeated as desired.

The methods described above can be varied and/or modified. For example, in one variation, the growth medium may be inoculated with desired cells and/or microorganisms in order to allow one cell or microorganism type to proliferate faster than background cells and/or microorganisms. In this manner, desired byproducts may be preferentially produced. For example, a culture medium may be inoculated with streptococcus thermophilus and lactobacillus bulgaricus (bacteria generally found in yogurt) in order to produce lactic acid that may help dissolve hard water deposits.

In another variation on the methods for removing hard water deposits with growth medium, the growth medium may be cared for in any manner that optimizes or increases cell and/or microorganism proliferation. In one instance, the growth medium may be heated or cooled in order to optimize proliferation. For example, dishes that have trace amounts of hard water deposits may be placed in a container of growth medium and kept at 37 degrees Celsius until the deposits are removed. In another example, growth medium that is applied to surfaces that are generally exposed to heat and/or wind (e.g., stone walls in the summer) may be shaded or shielded to allow the cells and/or microorganisms to proliferate optimally.

In another example of a method for caring for the growth medium in a manner that may increase or optimize cell and/or microorganism proliferation, growth medium may be mixed, stirred, shaken, or otherwise oxygenated. For example, a vat that has hard water deposits may be filled with growth medium and may be mechanically mixed or magnetically stirred in order to encourage cell and/or microorganism growth.

In addition to any previously indicated variation, the present invention may be varied, modified, or embodied in other specific forms without departing from its methods, compositions, or essential characteristics as broadly described herein and claimed hereinafter. The described embodiments are to be considered in all respects only as illustrative and not restrictive. The scope of the invention is, therefore, indicated by the appended claims, rather than by the foregoing description. All changes that come within the meaning and range of equivalency of the claims are to be embraced within their scope.

1. A method for removing unwanted mineral deposits on a substrate, comprising:
applying growth medium to mineral deposits;
growing cells or microorganisms within the growth medium to produce byproducts;
allowing the cells, microorganisms, or their byproducts to dissolve some or all of the unwanted mineral deposits; and
removing the growth medium and associated cells, microorganisms, byproducts and mineral deposits.

2. The method for removing unwanted mineral deposits of claim 1, further comprising the step of applying additional growth medium to the unwanted materials before the growth medium is removed.

3. The method for removing unwanted mineral deposits of claim 1, wherein the mineral deposits are selected from calcium carbonate and magnesium carbonate.

4. The method for removing unwanted mineral deposits of claim 1, wherein the mineral deposits comprise a metal oxide or surface oxidation selected from iron oxide, alumina, silica, and magnesium oxide.

5. The method for removing unwanted mineral deposits of claim 1, wherein the growth medium comprises a carbon source and a nitrogen source.

6. The method for removing unwanted mineral deposits of claim 5, wherein the carbon source is glucose, glycerol, or a weak acid.

7. The method for removing unwanted mineral deposits of claim 5, wherein the nitrogen source is selected from ammonium salts, proteins, peptides, amino acids, and inorganic nitrogen compounds.

8. The method for removing unwanted mineral deposits of claim 1, wherein the growth medium further comprises cell or microorganism specific nutrients, chemical, growth factors, or drugs.

9. The method for removing unwanted mineral deposits of claim 1, wherein the growth medium further comprises agar.

10. The method for removing unwanted mineral deposits of claim 1, wherein the cells or microorganisms comprise at least one of the following: bacteria, fungi, or protozoa.

11. The method for removing unwanted mineral deposits of claim 1, wherein the byproducts comprise at least one of the following: carbon dioxide, water, or an acid.

12. The method for removing unwanted materials of claim 1, wherein the growth medium may be removed by rinsing with water.

13. The method for removing unwanted mineral deposits of claim 1, wherein the cells or microorganisms are anaerobic.

14. The method for removing unwanted mineral deposits of claim 1, wherein the cells or microorganisms are aerobic.

15. The method for removing unwanted mineral deposits of claim 1, wherein the growth medium is inoculated with specific cells or microorganisms.

16. The method for removing unwanted mineral deposits of claim 1, wherein the step of growing the cells or microorganisms within the growth medium is promoted by heating, cooling, mixing, shaking, or stirring.
